(19) United States
(12) Patent Application Publication
(10) Pub. No.: US 2025/0292097 A1
(43) Pub. Date: Sep. 18, 2025

(54) OPTIMIZING GRAYSCALE RELEASE STRATEGIES BASED ON MULTIPLE OBJECTIVES AND CONSTRAINTS

(71) Applicant: INTERNATIONAL BUSINESS MACHINES CORPORATION, ARMONK, NY (US)

(72) Inventors: Si Heng Sun, XIAN (CN); Li Juan Gao, Xi'an (CN); Jun Guo, Xi'an (CN); Yu Zui You, Ningbo (CN); Chun Ni, Shenzhen (CN)

(21) Appl. No.: 18/604,799

(22) Filed: Mar. 14, 2024

(51) Int. Cl. G06N 3/092; G06N 3/045

(52) U.S. Cl. CPC G06N 3/092; G06N 3/045

(57) ABSTRACT

An embodiment for dynamically generating grayscale release strategies based on multi-objective optimization. The embodiment may define current state vector spaces and an action space for a target system. The embodiment may generate a composite reward function based on one or more objective-based reward functions and one or more constraint-based reward functions. The embodiment may generate, using a first network, candidate action vectors based on the defined current state vector spaces and the defined action space, the candidate action vectors corresponding to action probabilities. The embodiment may calculate, using a second network, state value functions based on the candidate action vectors. The embodiment may execute, in training iterations, actions corresponding to the candidate action vectors to obtain environment feedback including observed rewards. The embodiment may optimize the first and second networks. The embodiment may generate gray release strategies including a series of optimized actions to be taken.

### BACKGROUND

The present application relates generally to computer processing, and more particularly, to dynamically generating grayscale release strategies based on multi-objective optimization.

Grayscale release strategies, in the context of software development and deployment, involve deployment strategies where a new version of software is gradually rolled out to a subset of users before being released to an entire user base. Typically, grayscale releases (sometimes referred to as grey releases or canary releases) involve forwarding a small part of online traffic to a new version according to a proportion of requested traffic. After the new version is verified, the request ratios of the old and new versions are gradually increased. The step-by-step release methods of grayscale release strategies allow developers to monitor and assess performance and stability of new releases in a controlled manner, promoting smoothness of a given release and increased stability within the deploying environments. Businesses constantly strive to optimize release strategies for the deployment of software and associated updates to ensure positive user experiences for their customers.

### SUMMARY

According to one embodiment, a method, computer system, and computer program product for dynamically generating grayscale release strategies based on multi-objective optimization is provided. The embodiment may include defining current state vector spaces and an action space for a target system. The embodiment may also include generating a composite reward function based on one or more objective-based reward functions and one or more constraint-based reward functions. The embodiment may further include generating, using a first network, candidate action vectors based on the defined current state vector spaces and the defined action space, the candidate action vectors corresponding to action probabilities. The embodiment may also include calculating, using a second network, state value functions based on the candidate action vectors. The embodiment may further include executing, in training iterations, actions corresponding to the candidate action vectors to obtain environment feedback including observed rewards based on the generated composite reward function. The embodiment may also include optimizing the first and second networks based on the observed rewards. The embodiment may further include generating, using the optimized first and second networks, grayscale release strategies including a series of optimized actions to be taken.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of dynamically generating grayscale release strategies based on multi-objective optimization according to at least one embodiment; and

FIG. 3 illustrates an exemplary table of indicators and variables that may be incorporated within a defined current state vector space of a target system employing described methods according to at least one embodiment; and

FIG. 4 illustrates a diagrammatic view of an exemplary process of leveraging and training a series of neural networks to dynamically generate grayscale release strategies based on multi-objective optimization according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to dynamically (i.e. in real-time) generating grayscale release strategies based on multi-objective optimization. The following described exemplary embodiments provide a system, method, and program product to, among other things, define current state vector spaces and an action space for a target system, generate a composite reward function based on one or more objective-based reward functions and one or more constraint-based reward functions, generate, using a first network, candidate action vectors based on the defined current state vector spaces and the defined action space, the candidate action vectors corresponding to action probabilities, and calculate, using a second network, state value functions based on the candidate action vectors. The following described exemplary embodiments may then execute, in training iterations, actions corresponding to the candidate action vectors to obtain environment feedback including observed rewards based on the generated composite reward function, optimize, the first and second networks based on the observed rewards, and generate, using the optimized first and second networks, grayscale release strategies including a series of optimized actions to be taken.

As previously described, grayscale release strategies, in the context of software development and deployment, involve deployment strategies where a new version of software is gradually rolled out to a subset of users before being released to an entire user base. Typically, grayscale releases involve forwarding a small part of online traffic to a new version according to a proportion of requested traffic. After the new version is verified, the request ratios of the old and new versions are gradually increased. The step-by-step release methods of grayscale release strategies allow developers to monitor and assess performance and stability of new releases in a controlled manner, promoting smoothness of a given release and increased stability within the deploying environments. Businesses constantly strive to optimize release strategies for the deployment of software and associated updates to ensure positive user experiences for their customers.

However, there are several challenges faced when performing grayscale releases of enterprise-level applications. For example, grayscale releases of enterprise-level applications often involve the simultaneous change of multiple services, such that a request link may pass through dozens of microservices. These microservices may have complex dependencies therebetween, complicating the task of optimizing grayscale release strategy. This complicated environment typically requires manual intervention by maintenance personnel to formulate traffic grouping rules based on business needs with different traffic groups corresponding to different service link access paths. By observing the response of each service in the service link, and gradually adjusting the proportion of traffic grouping and the accessible path, a given entity may finally achieve the purpose of replacing the old version of the new version of the service in the entire system. Therefore, the design and implementation of a full-link grayscale release strategy can be extremely cumbersome and time-consuming. The entire process may be highly dependent on manual decision-making and experience. Operation and maintenance personnel may often invest significant time and energy into resolving challenges such as, how to dynamically adapt the proportion of traffic grouping and the instances deployed by the grayscale release strategy, how to handle the response status of each service node being different, how to determine when the grayscale release traffic increase or decreases, and how to optimally and dynamically adjust the size of grayscale release traffic increase with limited software and hardware resources. Accordingly, automated and intelligent methods of dynamically generating grayscale release strategies based on multi-objective optimization would be advantageous for many businesses presently relying on costly and time-consuming manual intervention to address a host of challenges in a complicated target environment.

Accordingly, a method, computer system, and computer program product for dynamically generating grayscale release strategies based on multi-objective optimization is provided. The method, system, and computer program product may define current state vector spaces and an action space for a target system. The method, system, computer program product may generate a composite reward function based on one or more objective-based reward functions and one or more constraint-based reward functions. The method, system, computer program product may then generate, using a first network, candidate action vectors based on the defined current state vector spaces and the defined action space, the candidate action vectors corresponding to action probabilities. The method, system, computer program product may calculate, using a second network, state value functions based on the candidate action vectors. Next, the method, system, computer program product may execute, in training iterations, actions corresponding to the candidate action vectors to obtain environment feedback including observed rewards based on the generated composite reward function. Then, the method, system, computer program product may optimize the first and second networks based on the observed rewards. Thereafter, the method, system, computer program product may generate, using the optimized first and second networks, grayscale release strategies including a series of optimized actions to be taken. In turn, the method, system, computer program product has provided for improved dynamic generation of grayscale release strategies based on multi-objective optimization using intelligent and automated techniques. Described embodiments leverage a combination of constraint-based and goal-based functions as incentive functions to help optimize grayscale release strategies in a manner which intelligently controls traffic for full-link grayscale releases. Described embodiments employ a series of neural networks to interpret current state vectors and action spaces which may then be leveraged to iteratively train the employed models based on a combined reward function to identify optimal grayscale release strategies as ideal actions to be taken are identified in view of the current state of the system and the observed rewards. Described embodiments thus allow for generation of optimized grayscale release strategies without the need for costly manual intervention, while solving for a series of objectives and constraints associated with what may be a complicated multi-service environment.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

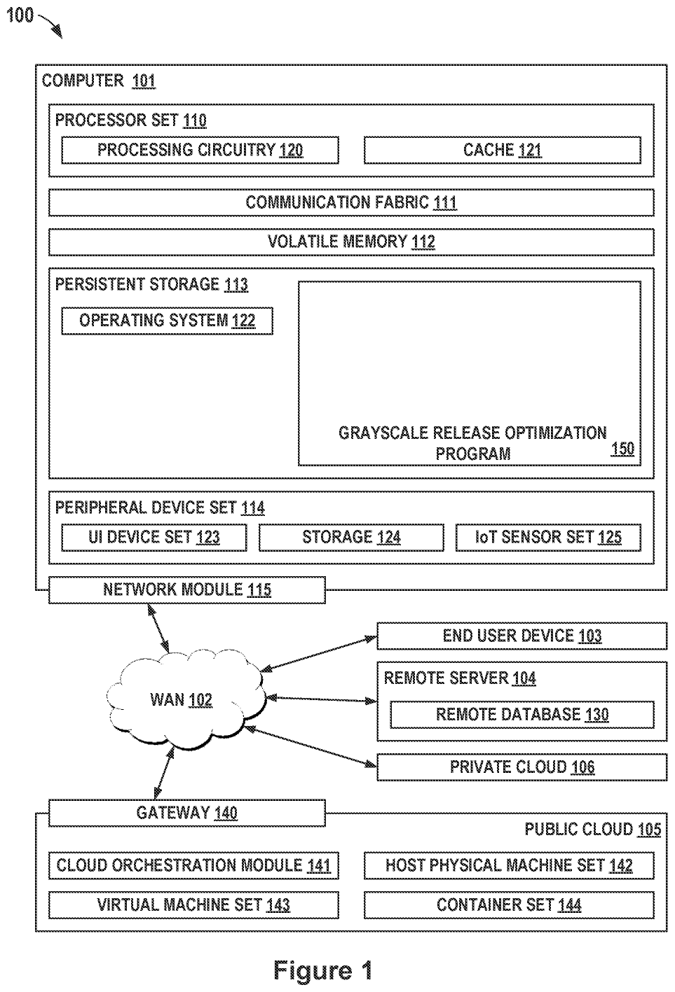

Referring now to FIG. 1, computing environment 100 contains an example of an environment for the execution of at least some of the computer code involved in performing the inventive methods, such as grayscale release optimization program/code 150. In addition to grayscale release optimization code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and grayscale release optimization code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in grayscale release optimization code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in grayscale release optimization program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the grayscale release optimization program 150 may be a program capable of defining current state vector spaces and an action space for a target system. Grayscale release optimization program 150 may then generate a composite reward function based on one or more objective-based reward functions and one or more constraint-based reward functions. Next, grayscale release optimization program 150 may generate, using a first network, candidate action vectors based on the defined current state vector spaces and the defined action space, the candidate action vectors corresponding to action probabilities. Grayscale release optimization program 150 may then calculate, using a second network, state value functions based on the candidate action vectors. Next, grayscale release optimization program 150 may execute, in training iterations, actions corresponding to the candidate action vectors to obtain environment feedback including observed rewards based on the generated composite reward function. Then, grayscale release optimization program may optimize the first and second networks based on the observed rewards. Thereafter, grayscale release optimization program 150 may generate, using the optimized first and second networks, grayscale release strategies including a series of optimized actions to be taken. In turn, the described method, system, computer program product has provided for improved dynamic generation of grayscale release strategies based on multi-objective optimization using intelligent and automated techniques. Described embodiments leverage a combination of constraint-based and goal-based functions as incentive functions to help optimize grayscale release strategies in a manner which intelligently controls traffic for full-link grayscale releases. Described embodiments employ a series of neural networks to interpret current state vectors and action spaces which may then be leveraged to iteratively train the employed models based on a combined reward function to identify optimal grayscale release strategies as ideal actions to be taken are identified in view of the current state of the system and the observed rewards. Described embodiments thus allow for generation of optimized grayscale release strategies without the need for costly manual intervention, while solving for a series of objectives and constraints associated with what may be a complicated multi-service environment.

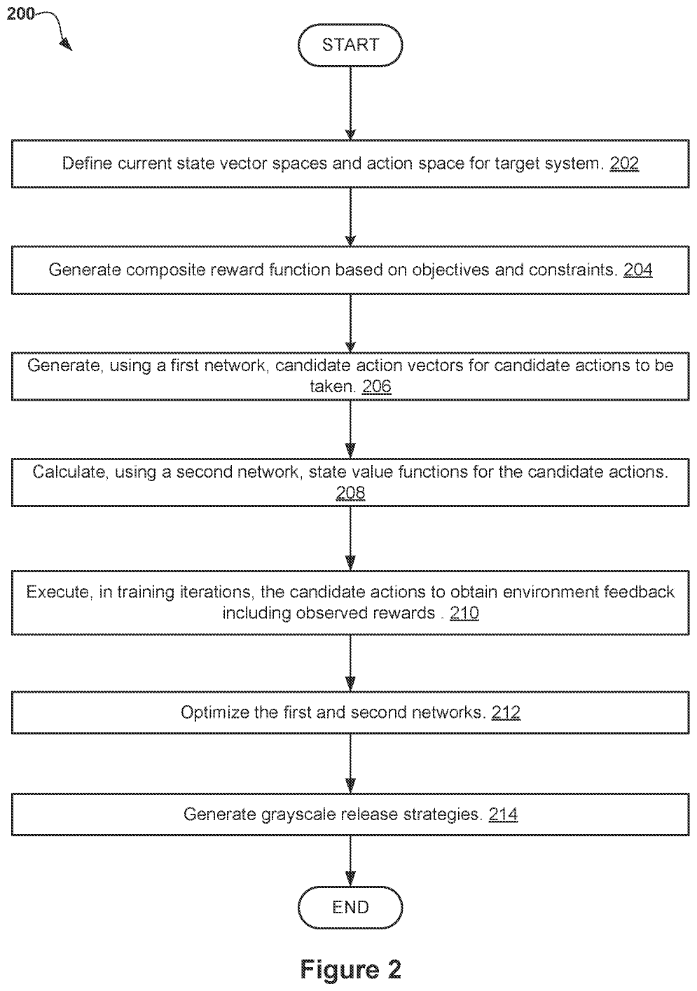

Referring now to FIG. 2, an operational flowchart for an illustrative process 200 of dynamically generating grayscale release strategies based on multi-objective optimization according to at least one embodiment is provided. While the description of presently described embodiments refer specifically to grayscale releases, it may be appreciated that described methods and release strategies may also be referred to as gray releases, canary releases, or any other suitable known language describing similar release strategies in which a new version of software or code is gradually rolled out to a subset of users before being released to an entire user base.

At 202, grayscale release optimization program 150 may define current state vector spaces and an action space for a target system. In embodiments, the target system may include any suitable environment into which, for example, software, applications, tools, or other code (such as updates or programs) may be deployed. The target system may include any suitable device or computer, such as computer 101, that is capable of receiving the deployment. In embodiments, the target system may include many devices of various types capable of receiving deployed updates or code. Both the defined current state vector spaces and the defined action space at 202 directly relate to features and data derived from the target system that will be leveraged to generate an optimized grayscale release.

In the context of this disclosure, the defined current state vector spaces may functionally describe the current state of the target system. In embodiments, the defined current state vector spaces may be constructed by selecting indicators or variables that can describe the health status and traffic conditions of each of a series of relevant service nodes at a given current time step. For example, for an exemplary target system ‘S’, an exemplary formula may be denoted as Sₙₜ, where n is the system number and t is the time step:

$${S}_{nt} = [ {u}_{cpu} , {u}_{mem} , {t}_{err} , {t}_{change} , {p}_{gray} ]$$

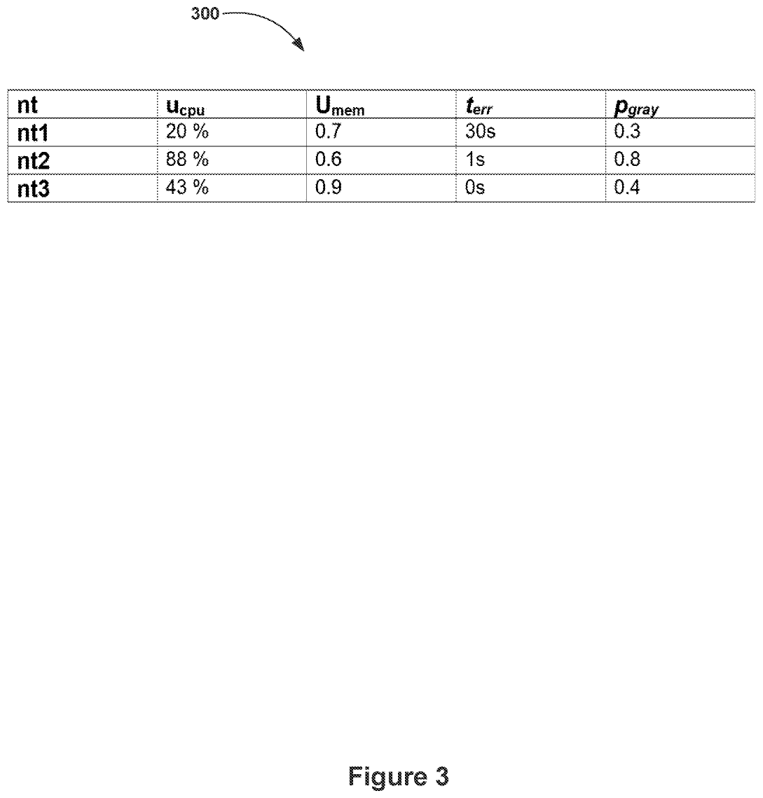

In the above formula, the defined current state vector spaces for the target system includes indicators and variables u_{cpu} corresponding to CPU utilization, uₘₑₘ corresponding to memory utilization, tₑᵣᵣ corresponding to error duration of the service which may represent the cumulative error duration of the system from the previous version release to the current time, measured, for example, in seconds, t_{change} corresponding to version switch time, representing the number of seconds the system has been running from the previous version release to the current time, and p_{gray} corresponding to a traffic ratio, representing the current proportion of gray traffic. In embodiments, for example, the values for the indicators or variables in the above expression may range from 0 to 1. FIG. 3 illustrates an exemplary table of indicators and variables 300 that may be incorporated within an exemplary defined current state vector space of a target system employing described methods according to at least one embodiment. For example, as shown in Table 310, when the gray traffic ratio is 0.3, the value of p_{gray} would be 0.3. At this step, grayscale release optimization program 150 would use these values as state variables for the exemplary target system ‘S’ and encode them, using any suitable encoding techniques, into vector form. For example, grayscale release optimization program 150 may convert system resource usage values into a binary containing CPU and memory usage, and all state variables could then be concatenated to form a current state vector.

In the context of this disclosure, the defined action space for a target system may refer to any set of operations that can be performed on the target system. In embodiments, the defined action space may be denoted, for example, as an exemplary symbol ‘A’ and represented using a discrete set of actions. In embodiments, for example, the defined action space may be represented by the following expression:

$$A = \{ {a}_{1} , {a}_{2} , … , {a}_{m} \}$$

In the above exemplary expression, m is the number of actions, and each action aᵢ represents an operation on the system. For example, ‘a1’ may correspond to an action of increasing the gray traffic ratio by 0.1, ‘a2’ may correspond to an action of decreasing the gray traffic ratio by 0.1, ‘a3’ may correspond to an action of increasing the version switch time by 10 seconds, and so on. In embodiments, to make the actions more fine-grained, a specific incremental value may be defined for each action aᵢ. For example:

$$Δ {p}_{gray} = \{ \begin{matrix}+ 0.1 , & {a}_{i} = increase gray traffic ratio \\ - 0.1 , & {a}_{i} = decrease gray traffic ratio \\ 0 & otherwise .\end{matrix}$$

$$Δ {t}_{change} = \{ \begin{matrix}+ 10 , & {a}_{i} = increase version switch time \\ - 10 , & {a}_{i} = decrease version switch time \\ 0 & otherwise .\end{matrix}$$

In an embodiment involving the above expressions, each specific operation corresponding to an action aᵢ may be achieved by increasing or decreasing the corresponding variable in the defined current state vector Sₙₜ using Δp_{gray} or Δt_{change}, respectively. In this example, grayscale release optimization program 150 is functionally defining an exemplary action space related to grayscale traffic adjustment. Using grayscale traffic proportion as an action variable, grayscale release optimization program 150 defines the action space as a continuous range, such as real numbers between [0,1]. In embodiments, gauss strategy may be used to sample actions, where the mean is given by a neural network (discussed in greater detail below), and the variance is a hyperparameter, which can be adjusted to control the degree of action exploration.

As stated above, both the current state vector spaces and the action space defined for the target system by grayscale release optimization program 150 at 202 directly relate to features and data derived from the target system that will be leveraged to generate an optimized grayscale release.

At 204, grayscale release optimization program 150 may generate a composite reward function based on one or more objective-based reward functions and one or more constraint-based reward functions. For example, in embodiments, grayscale release optimization program 150 may be configured to leverage objective-based reward functions incorporating relevant optimization objectives as part of the reward function, typically by converting them into negative loss functions. For example, a suitable exemplary objective-based reward function usable by grayscale release optimization program 150 may be expressed as:

$$R ( st , at ) = α 1 * CPU utilization + α 2 * memory utilization + α 3 * error \\ \\ duration + α 4 * version switch time + α 5 * gray traffic ratio trend \\ \\ increase$$

In the above exemplary expression, α1, α2, α3, α4, α5 are hyperparameters used to adjust the weights of different optimization objectives and may be set based on the importance of different optimization objectives for the given target system.

Grayscale release optimization program 150 may be further configured to leverage constraint-based reward functions, that is functions which incorporate constraint conditions as part of the reward function by assigning penalty values when the constraints are violated. For example, grayscale release optimization program 150 may be configured to leverage an exemplary constraint-based reward function represented by the following expressions:

$$R ( s t , a t ) = \{ \begin{matrix}- 1 , & if CPU utilization or memory utilization exceeds the threshold \\ - 1 , & if error duration exceeds 5 minutes \\ - 1 , & if response time exceeds 2 seconds \\ - 1 , & if gray traffic ratio increases too rapidly \\ 0 , & otherwise .\end{matrix}$$

Accordingly, at this step, grayscale release optimization program 150 may combine the relevant objective-based and constraint-based reward functions associated with the target system to form a composite reward function that encompasses both the sets of objectives and relevant constraints. For example, using the illustrative expressions presented and discussed above, at 204, grayscale release optimization program 150 may generate a composite reward function represented by the following expression:

$${R}_{( {s}_{t} , {a}_{t} )} = Wgoal * {R}_{goal ( {s}_{t} , {a}_{t} )} + Wcondition * {R}_{condition ( {s}_{t} , {a}_{t} )}$$

In embodiments, the composite reward function formed by grayscale release optimization program 150 may include rewards for various circumstances. For example, in some embodiments grayscale release optimization program 150 may include a composite reward function which rewards each time step where the system resource usage and error reporting duration correspond to two negative rewards, while the switching time between new and old versions and the grayscale traffic ratio correspond to two positive rewards. In other embodiments, an exemplary composite reward function may reward for system timeouts. For example, if an error is reported for more than 5 minutes, a small negative reward will be given and the training will be stopped. In yet another embodiment, an exemplary composite reward function may reward for achieving 100% grayscale traffic ratio such that if the grayscale traffic ratio reaches 100%, a large positive reward is given and training is stopped. A variety of other suitable or desirable combined reward functions are envisioned as may be useful in a given target system and context.

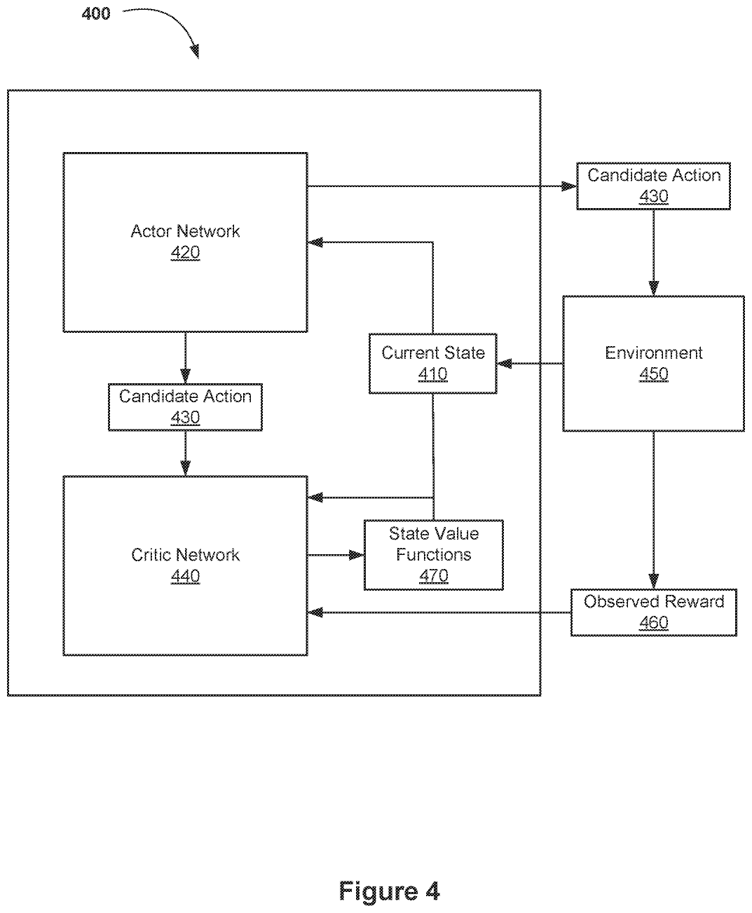

FIG. 4 illustrates a diagrammatic view of an exemplary process 400 of leveraging and training a series of neural networks to dynamically generate grayscale release strategies based on multi-objective optimization according to at least one embodiment and will be referenced throughout the discussions of the remaining steps of illustrative process 200.

Next, at 206, grayscale release optimization program 150 may generate, using a first network, candidate action vectors based on the defined current state vector spaces and the defined action space, the candidate action vectors corresponding to action probabilities. In embodiments, grayscale release optimization program 150 may generate the candidate action vectors by leveraging a first network which includes an actor neural network configured to take current state vectors for the target system as inputs to output the candidate action vectors. The candidate action vectors represent probability distributions of actions to be executed (taken) for a given current state associated with the target system. In FIG. 4, an exemplary process 400 is shown in which an illustrative actor network 420 is configured to receive current state vectors 410 for a target system to output candidate action vectors 430 corresponding to candidate actions to be taken.

At 208 grayscale release optimization program 150 may calculate, using a second network, state value functions based on the candidate action vectors. In embodiments, the second network may be, for example, a critic network configured to receive the candidate actions (from the actor network) as input and output state values representing efficiency scores for the respective candidate actions based on the current state. In some embodiments, for example, the state value or efficiency scores may be reflective of the expected resource utilization within a given target system, or reflective of some overall expected effect on the target system if the candidate action were taken. This step is illustrated in FIG. 4, in which an exemplary critic network 440 receives, as inputs, the candidate action vectors 430 from the actor network 420 and outputs state value functions 460.

At 210, grayscale release optimization program 150 may execute, in training iterations, actions corresponding to the candidate action vectors to obtain environment feedback including observed rewards based on the generated composite reward function. At this step, as shown in FIG. 4, the candidate actions corresponding to candidate action vectors 430 may be executed within an exemplary environment 450 to generate feedback including observed rewards 470 based on the generated composite reward function from step 204. In some embodiments, grayscale release optimization program 150 may be configured to initialize the utilized neural network parameters and experience pools by randomly initializing the parameters of the actor and critic neural networks, setting up a suitable optimizer (such as, for example, the Adam optimizer), and defining an experience pool to store the interaction data between an agent and the environment 450, including the current state of the target system, the executed actions, received rewards, and next state. In embodiments, grayscale release optimization program 150 may use a suitable dense layer and ReLU activation function to build the suitable neural networks and take the state vector as the input while at the same time, using a gradually decreasing greedy strategy to balance exploration and utilization.

Next, at 212, grayscale release optimization program 150 may optimize the first and second networks based on the observed rewards. As grayscale release optimization program 150 continues to leverage the first and second networks, continuous training iterations are executed in which the exemplary environment continuously executes a given action to be taken in the current state, executes the action, and observes the environment's feedback, including the next state and obtained reward. In embodiments, when the amount of data in the experience pool reaches a predetermined threshold value, grayscale release optimization program 150 may be configured to randomly sample a batch of data from it to update the neural networks' respective parameters. Grayscale release optimization program 150 may then compute loss functions and update the respective parameters of the first (actor) and second (critical) networks by calculating the loss function for the sampled data. In embodiments, grayscale release optimization program 150 may be configured to further leverage a suitable optimizer to update the parameters of both networks, aiming to minimize the loss function. Grayscale release optimization program 150 may then repeat the above steps until the first and second networks converge or reach a predefined maximum number of iterations, thereby optimizing the first and second networks over time based on the observed rewards derived from the composite reward function which inherently includes both objective-based features and constraint-based features within the original functions used to form the composite reward function.

At 214, grayscale release optimization program 150 may generate, using the optimized first and second networks, grayscale release strategies including a series of optimized actions to be taken. By using the above-described processes, grayscale release optimization program 150 may generate an optimized grayscale release strategy with a series of optimal actions in view of the relevant constraints and objectives for the target system built into the composite reward function from step 204. Thus, through intelligent traffic allocation and dynamic deployment adjustment of new and old versions, the optimization and intelligence of grayscale release optimization program 150 may be realized and either executed automatically or output to a user for confirmation.

It may be appreciated that grayscale release optimization program 150 has thus provided improved methods of dynamically generating grayscale release strategies based on multi-objective optimization in which the utilization rate of system resources and the efficiency of grayscale releases is improved. Furthermore, multi-objective optimization is achieved while balancing the use of system resources, switching time between old and new versions, service accuracy, grayscale traffic ratio, node resource usage, etc. thereby improving the overall performance and stability of the system.

Illustrative embodiments of grayscale release optimization program 150 leverage a combination of constraint-based and goal-based functions as incentive functions to help optimize grayscale release strategies in a manner which intelligently controls traffic for full-link grayscale releases. Described embodiments further employ a series of neural networks to interpret current state vectors and action spaces which may then be leveraged to iteratively train the employed models based on a combined reward function to identify optimal grayscale release strategies as ideal actions to be taken are identified in view of the current state of the system and the observed rewards. Described embodiments thus allow for generation of optimized grayscale release strategies without the need for costly manual intervention, while solving for a series of objectives and constraints associated with what may be a complicated multi-service environment.

Presently described embodiments may relate to the following clauses:

Clause 1: A computer-based method of dynamically generating grayscale release strategies based on multi-objective optimization, the method including: defining current state vector spaces and an action space for a target system, generating a composite reward function based on one or more objective-based reward functions and one or more constraint-based reward functions, generating, using a first network, candidate action vectors based on the defined current state vector spaces and the defined action space, the candidate action vectors corresponding to action probabilities, calculating, using a second network, state value functions based on the candidate action vectors, executing, in training iterations, actions corresponding to the candidate action vectors to obtain environment feedback including observed rewards based on the generated composite reward function, optimizing the first and second networks based on the observed rewards, and generating, using the optimized first and second networks, grayscale release strategies including a series of optimized actions to be taken. Described embodiments thus provide improved dynamic generation of grayscale release strategies based on multi-objective optimization using intelligent and automated techniques. Described embodiments employ a series of neural networks to interpret current state vectors and action spaces which may then be leveraged to iteratively train employed models based on a combined reward function to identify optimal grayscale release strategies as ideal actions to be taken are identified in view of the current state of the system and the observed rewards.

Clause 2: The computer-based method of clause 1, wherein the one or more objective-based reward functions further include hyperparameters to attribute respective weights to a series of variables in the one or more objective-based reward functions. This allows described embodiments to prioritize certain resources or optimization objectives of a target system appropriately to enhance the ability of described embodiments to effectively generate optimized grayscale release strategies which are tailored to the target system.

Clause 3: The computer-based method of any of the preceding clauses 1-2, wherein the state value functions include efficiency scores corresponding to the candidate action vectors generated by the first network. This allows described embodiments to quantify, based on the candidate action vectors, the expected effect on a target system if a candidate action were taken, which improves the ability of described embodiments to more effectively generate optimal grayscale release strategies.

Clause 4: The computer-based method of any of the preceding clauses 1-3, wherein optimizing the first and the second networks based on the observed rewards further includes, in response to an amount of data in an experience pool reaching a predetermined threshold value, randomly sampling a batch of data to update parameters of the first network and the second network respectively. This allows described embodiments to efficiently train and update parameters of employed neural networks through iterative training steps, which over time enables described embodiments to leverage the employed neural networks to generate optimized grayscale release strategies.

Clause 5: The computer-based method of any of the preceding clauses 1-4, the method further including continuously updating the parameters of the first network and the second network respectively until the first network and the second network converge or reach a predefined maximum number of iterations. This allows described embodiments to iteratively optimizes the employed first and second networks for generating optimal grayscale release strategies, while also providing for customizability of the extent to which the employed models are iteratively trained and optimized based on the specific properties or features of a given environment or target system in which described embodiments are being employed.

Clause 6: The computer-based method of any of the preceding clauses 1-5, wherein the defined current state vector spaces comprise a series of variables related to at least a current health status and traffic conditions at a given time of at least one or more service nodes associated with the target system. This allows described embodiments to ensure the traffic conditions and status of service nodes in a target system or environment are fully considered when generating optimal grayscale release strategies.

Clause 7: The computer-based method of any of the preceding clauses 1-6, wherein the defined action space includes a series of performable operations corresponding to actions that are achievable by modifying one or more variables in the series of variables included within the defined current state vector. Described embodiments may thus, while generating optimized grayscale release strategies, fully consider any potential actions which would modify factors or variables that may impact the current state of a given target system.

Clause 8: one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method including: defining current state vector spaces and an action space for a target system, generating a composite reward function based on one or more objective-based reward functions and one or more constraint-based reward functions, generating, using a first network, candidate action vectors based on the defined current state vector spaces and the defined action space, the candidate action vectors corresponding to action probabilities, calculating, using a second network, state value functions based on the candidate action vectors, executing, in training iterations, actions corresponding to the candidate action vectors to obtain environment feedback including observed rewards based on the generated composite reward function, optimizing the first and second networks based on the observed rewards, and generating, using the optimized first and second networks, grayscale release strategies including a series of optimized actions to be taken. Described embodiments thus provide improved dynamic generation of grayscale release strategies based on multi-objective optimization using intelligent and automated techniques. Described embodiments employ a series of neural networks to interpret current state vectors and action spaces which may then be leveraged to iteratively train employed models based on a combined reward function to identify optimal grayscale release strategies as ideal actions to be taken are identified in view of the current state of the system and the observed rewards.

Clause 9: The computer system of clause 8, wherein the one or more objective-based reward functions further include hyperparameters to attribute respective weights to a series of variables in the one or more objective-based reward functions. This allows described embodiments to prioritize certain resources or optimization objectives of a target system appropriately to enhance the ability of described embodiments to effectively generate optimized grayscale release strategies which are tailored to the target system.

Clause 10: The computer system of any of the preceding clauses 8-9, wherein the state value functions include efficiency scores corresponding to the candidate action vectors generated by the first network. This allows described embodiments to quantify, based on the candidate action vectors, the expected effect on a target system if a candidate action were taken, which improves the ability of described embodiments to more effectively generate optimal grayscale release strategies.

Clause 11: The computer system of any of the preceding clauses 8-10, wherein optimizing the first and the second networks based on the observed rewards further includes, in response to an amount of data in an experience pool reaching a predetermined threshold value, randomly sampling a batch of data to update parameters of the first network and the second network respectively. This allows described embodiments to efficiently train and update parameters of employed neural networks through iterative training steps, which over time enables described embodiments to leverage the employed neural networks to generate optimized grayscale release strategies.

Clause 12: The computer system of any of the preceding clauses 8-11, the method further including continuously updating the parameters of the first network and the second network respectively until the first network and the second network converge or reach a predefined maximum number of iterations. This allows described embodiments to iteratively optimizes the employed first and second networks for generating optimal grayscale release strategies, while also providing for customizability of the extent to which the employed models are iteratively trained and optimized based on the specific properties or features of a given environment or target system in which described embodiments are being employed.

Clause 13: The computer system of any of the preceding clauses 8-12, wherein the defined current state vector spaces comprise a series of variables related to at least a current health status and traffic conditions at a given time of at least one or more service nodes associated with the target system. This allows described embodiments to ensure the traffic conditions and status of service nodes in a target system or environment are fully considered when generating optimal grayscale release strategies.

Clause 14: The computer system of any of the preceding clauses 8-13, wherein the defined action space includes a series of performable operations corresponding to actions that are achievable by modifying one or more variables in the series of variables included within the defined current state vector. Described embodiments may thus, while generating optimized grayscale release strategies, fully consider any potential actions which would modify factors or variables that may impact the current state of a given target system.

Clause 15: A computer program product, the computer program product including: one or more computer-readable tangible storage medium and program instructions stored on at least one of the one or more computer-readable tangible storage medium, the program instructions executable by a processor capable of performing a method, the method including: defining current state vector spaces and an action space for a target system, generating a composite reward function based on one or more objective-based reward functions and one or more constraint-based reward functions, generating, using a first network, candidate action vectors based on the defined current state vector spaces and the defined action space, the candidate action vectors corresponding to action probabilities, calculating, using a second network, state value functions based on the candidate action vectors, executing, in training iterations, actions corresponding to the candidate action vectors to obtain environment feedback including observed rewards based on the generated composite reward function, optimizing the first and second networks based on the observed rewards, and generating, using the optimized first and second networks, grayscale release strategies including a series of optimized actions to be taken. Described embodiments thus provide improved dynamic generation of grayscale release strategies based on multi-objective optimization using intelligent and automated techniques. Described embodiments employ a series of neural networks to interpret current state vectors and action spaces which may then be leveraged to iteratively train employed models based on a combined reward function to identify optimal grayscale release strategies as ideal actions to be taken are identified in view of the current state of the system and the observed rewards.

Clause 16: The computer program product of clause 15, wherein the one or more objective-based reward functions further include hyperparameters to attribute respective weights to a series of variables in the one or more objective-based reward functions. This allows described embodiments to prioritize certain resources or optimization objectives of a target system appropriately to enhance the ability of described embodiments to effectively generate optimized grayscale release strategies which are tailored to the target system.

Clause 17: The computer program product of any of the preceding clauses 15-16, wherein the state value functions include efficiency scores corresponding to the candidate action vectors generated by the first network. This allows described embodiments to quantify, based on the candidate action vectors, the expected effect on a target system if a candidate action were taken, which improves the ability of described embodiments to more effectively generate optimal grayscale release strategies.

Clause 18: The computer program product of any of the preceding clauses 15-17, wherein optimizing the first and the second networks based on the observed rewards further includes, in response to an amount of data in an experience pool reaching a predetermined threshold value, randomly sampling a batch of data to update parameters of the first network and the second network respectively. This allows described embodiments to efficiently train and update parameters of employed neural networks through iterative training steps, which over time enables described embodiments to leverage the employed neural networks to generate optimized grayscale release strategies.

Clause 19: The computer program product of any of the preceding clauses 15-18, the method further including continuously updating the parameters of the first network and the second network respectively until the first network and the second network converge or reach a predefined maximum number of iterations. This allows described embodiments to iteratively optimizes the employed first and second networks for generating optimal grayscale release strategies, while also providing for customizability of the extent to which the employed models are iteratively trained and optimized based on the specific properties or features of a given environment or target system in which described embodiments are being employed.

Clause 20: The computer program product of any of the preceding clauses 15-19, wherein the defined current state vector spaces comprise a series of variables related to at least a current health status and traffic conditions at a given time of at least one or more service nodes associated with the target system. This allows described embodiments to ensure the traffic conditions and status of service nodes in a target system or environment are fully considered when generating optimal grayscale release strategies.

It may be appreciated that FIGS. 2-4 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of dynamically generating grayscale release strategies based on multi-objective optimization, the method comprising:
defining current state vector spaces and an action space for a target system;
generating a composite reward function based on one or more objective-based reward functions and one or more constraint-based reward functions;
generating, using a first network, candidate action vectors based on the defined current state vector spaces and the defined action space, the candidate action vectors corresponding to action probabilities;
calculating, using a second network, state value functions based on the candidate action vectors;
executing, in training iterations, actions corresponding to the candidate action vectors to obtain environment feedback including observed rewards based on the generated composite reward function;
optimizing the first and second networks based on the observed rewards; and
generating, using the optimized first and second networks, grayscale release strategies including a series of optimized actions to be taken.

2. The computer-based method of claim 1, wherein the one or more objective-based reward functions further include hyperparameters to attribute respective weights to a series of variables in the one or more objective-based reward functions.

3. The computer-based method of claim 1, wherein the state value functions comprise efficiency scores corresponding to the candidate action vectors generated by the first network.

4. The computer-based method of claim 1, wherein optimizing the first and the second networks based on the observed rewards further comprises:
in response to an amount of data in an experience pool reaching a predetermined threshold value, randomly sampling a batch of data to update parameters of the first network and the second network respectively.

5. The computer-based method of claim 4, the method further comprising:
continuously updating the parameters of the first network and the second network respectively until the first network and the second network converge or reach a predefined maximum number of iterations.

6. The computer-based method of claim 1, wherein the defined current state vector spaces comprise a series of variables related to at least a current health status and traffic conditions at a given time of at least one or more service nodes associated with the target system.

7. The computer-based method of claim 6, wherein the defined action space comprises a series of performable operations corresponding to actions that are achievable by modifying one or more variables in the series of variables included within the defined current state vector.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
defining current state vector spaces and an action space for a target system;
generating a composite reward function based on one or more objective-based reward functions and one or more constraint-based reward functions;
generating, using a first network, candidate action vectors based on the defined current state vector spaces and the defined action space, the candidate action vectors corresponding to action probabilities;
calculating, using a second network, state value functions based on the candidate action vectors;
executing, in training iterations, actions corresponding to the candidate action vectors to obtain environment feedback including observed rewards based on the generated composite reward function;
optimizing the first and second networks based on the observed rewards; and
generating, using the optimized first and second networks, grayscale release strategies including a series of optimized actions to be taken.

9. The computer system of claim 8, wherein the one or more objective-based reward functions further include hyperparameters to attribute respective weights to a series of variables in the one or more objective-based reward functions.

10. The computer system of claim 8, wherein the state value functions comprise efficiency scores corresponding to the candidate action vectors generated by the first network.

11. The computer system of claim 8, wherein optimizing the first and the second networks based on the observed rewards further comprises:
in response to an amount of data in an experience pool reaching a predetermined threshold value, randomly sampling a batch of data to update parameters of the first network and the second network respectively.

12. The computer system of claim 11, the method further comprising:
continuously updating the parameters of the first network and the second network respectively until the first network and the second network converge or reach a predefined maximum number of iterations.

13. The computer system of claim 8, wherein the defined current state vector spaces comprise a series of variables related to at least a current health status and traffic conditions at a given time of at least one or more service nodes associated with the target system.

14. The computer system of claim 13, wherein the defined action space comprises a series of performable operations corresponding to actions that are achievable by modifying one or more variables in the series of variables included within the defined current state vector.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
defining current state vector spaces and an action space for a target system;
generating a composite reward function based on one or more objective-based reward functions and one or more constraint-based reward functions;
generating, using a first network, candidate action vectors based on the defined current state vector spaces and the defined action space, the candidate action vectors corresponding to action probabilities;
calculating, using a second network, state value functions based on the candidate action vectors;
executing, in training iterations, actions corresponding to the candidate action vectors to obtain environment feedback including observed rewards based on the generated composite reward function;
optimizing the first and second networks based on the observed rewards; and
generating, using the optimized first and second networks, grayscale release strategies including a series of optimized actions to be taken.

16. The computer program product of claim 15, wherein the one or more objective-based reward functions further include hyperparameters to attribute respective weights to a series of variables in the one or more objective-based reward functions.

17. The computer program product of claim 15, wherein the state value functions comprise efficiency scores corresponding to the candidate action vectors generated by the first network.

18. The computer program product of claim 15, wherein optimizing the first and the second networks based on the observed rewards further comprises:
in response to an amount of data in an experience pool reaching a predetermined threshold value, randomly sampling a batch of data to update parameters of the first network and the second network respectively.

19. The computer program product of claim 18, the method further comprising:
continuously updating the parameters of the first network and the second network respectively until the first network and the second network converge or reach a predefined maximum number of iterations.

20. The computer program product of claim 15, wherein the defined current state vector spaces comprise a series of variables related to at least a current health status and traffic conditions at a given time of at least one or more service nodes associated with the target system.
